(19) United States
(12) Patent Application Publication
(10) Pub. No.: US 2019/0143853 A1
(43) Pub. Date: May 16, 2019

(54) EZ-Ride Car Seat Tray

(71) Applicant: Noveen Seeborun, Houston, TX (US)

(72) Inventor: Noveen Seeborun, Houston, TX (US)

(21) Appl. No.: 15/966,854

(22) Filed: Apr. 30, 2018

Related U.S. Application Data
(60) Provisional application No. 62/585,147, filed on Nov. 13, 2017.

(51) Int. Cl. B60N 2/28; B60N 3/00; B60N 2/56; B60Q 3/233

(52) U.S. Cl. CPC B60N 2/2839; B60Q 3/233; B60N 2/5621; B60N 3/002

(57) ABSTRACT

During long car rides, children often sit in their car seats and complain about boredom. A car-seat tray is introduced for connection to a car seat. The tray provides a space for eating and for play. And the tray provides an adjustable easel. Some versions have lights such as reading lights and ventilation such as a fan.

### CROSS-REFERENCE TO RELATED APPLICATION(S)

The present application is related to and claims priority to U.S. Provisional Patent Application No. 62/585,147 filed Nov. 13, 2017, which is incorporated by reference herein in its entirety.

### TECHNICAL FIELD

The present invention relates generally to the field of car safety seats and more specifically relates to accessories for car safety seats for children.

### BACKGROUND

The following includes information that may be useful in understanding the present disclosure. It is not an admission that any of the information provided herein is prior art nor material to the presently described or claimed inventions, nor that any publication or document that is specifically or implicitly referenced is prior art.

During long car rides, children often sit in their car seats and complain about boredom. Parents spend hours driving while listening to whining because children do not stay entertained. It can be difficult for children to hold a book or toy in the upright position for a prolonged period, and it is hard to draw or write without a hard surface. In addition, children often must wait until a rest stop to eat, because the car lacks table space. A suitable solution is desired.

### Related Art

U.S. Pat. No. 4,770,468 to Shubin relates to a child safety car seat. The child safety car seat includes an automobile car seat for a child with a tray that is pivoted slightly above and behind the shoulders of the child who sits in the seat. Shoulder and lap straps are secured to the pivoted tray structure so that as the tray is swung down into position, the shoulder and lap straps automatically come into position to hold the child in place. The tray is provided with a large padded center post that locks into the seat as the tray is swung forward into position. As the child gets older and bigger, the position of the shoulder straps may be raised and locked into their new position. The seat and back may be tilted as a unit by raising the front of the seat, so that the child can lean back and sleep.

### SUMMARY

In view of the foregoing disadvantages inherent in the known car seat art, the present disclosure provides a novel car-seat tray. The general purpose of this disclosure, which will be described subsequently in greater detail, is to provide an efficient and effective car-seat tray.

A car-seat tray is disclosed. The car-seat tray has a car-seat mount disposed between a platform and a car seat, a children's car seat, or a forward-facing children's car seat, an easel connected to the platform, and a fan or an enclosed fan. The platform is connected to a car seat mount. In some version, the car-seat tray has lights or reading lights, in some version these are LED lights. The lights and fan are powered by an internal or external power supply, in some versions a battery-based power supply. The power supply can contain switches for the lights or fan.

Car-seat tray has an angled leg movably connected to the easel or the platform and in some version the angled leg sits between the easel and the platform and the easel rests in an elevated position.

Some car-seat tray versions have a car-seat mount that includes jaws adapted to engage car seat sides. These or other car-seat tray versions can have book clips and the book clips can connect to the easel.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a Car Seat Tray, constructed and operative according to the teachings of the present disclosure.

FIG. 1 is a perspective view of a version of a car-seat tray during an ‘in-use’ condition.

FIG. 2A is a perspective view of the tray of FIG. 1.

FIG. 2B is another perspective view of the tray of FIG. 1.

FIG. 3 is an exploded view of the tray of FIG. 1.

FIG. 4A is a perspective view an alternative version of a car-seat tray.

FIG. 4B is a perspective view an alternative version of a car-seat tray.

FIG. 5 is a perspective view of an alternative version of a car-seat tray.

The various embodiments of the present invention will hereinafter be described in conjunction with the appended drawings, wherein like designations denote like elements.

### DETAILED DESCRIPTION

As discussed above, the present disclosure relates to a car-seat tray, which improves typical car or automobile child safety seats.

Child safety seats are seats designed specifically to protect children from injury during collisions. Car manufacturers may integrate these seats directly into their vehicle's design. But most commonly these seats are purchased and installed by consumers. Many regions require children of certain age, weight, or height requirements to use a government-approved child safety seat when riding in a vehicle. To provide proper passive restraint, the seats must be used properly.

The present invention provides a car-seat tray 100 that is clamped to a child's car seat and can be used for reading, eating, sleeping, drawing, or other activities. It allows children to better entertain themselves during a car ride, especially on long trips. It allows children to eat meals and snacks while on-the-go by providing table space for food and drinks. It supplies a fan to ventilate the backseat. The present invention allows parents to drive with the peace of mind that their children are fully accommodated.

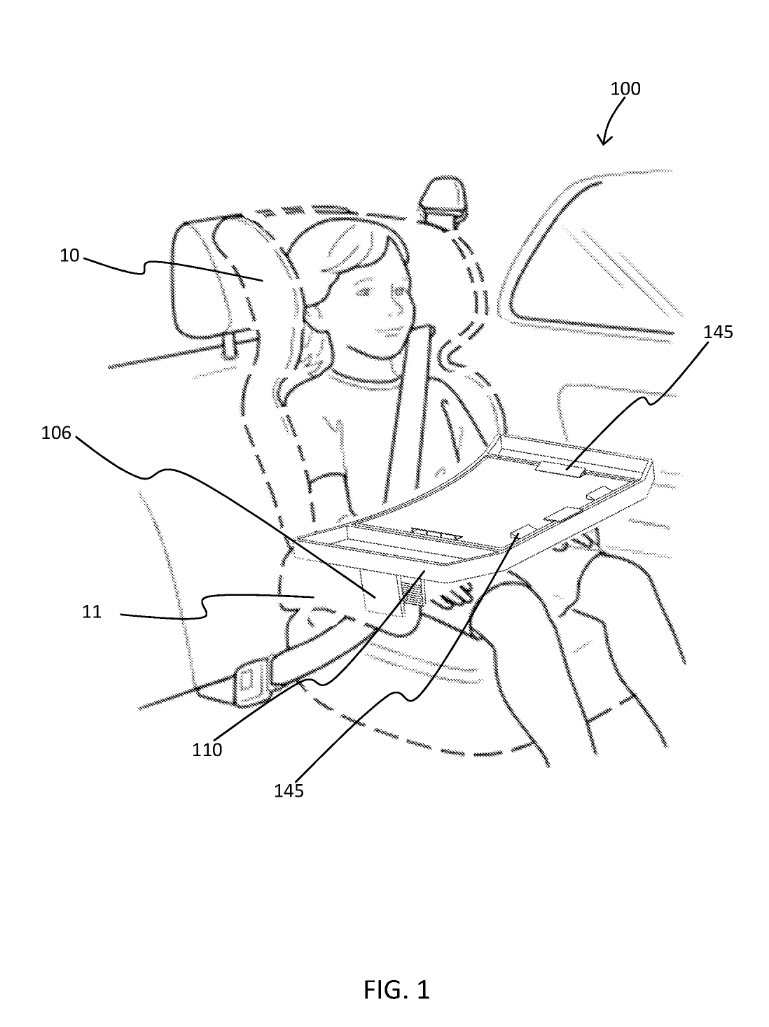

Referring now more specifically to the drawings by numerals of reference, there is shown in FIGS. 1-5, various views of car-seat tray 100.

FIG. 1 depicts a prior art car seat 10 with a version of the disclosed car-seat tray, according to this disclosure. Car-seat tray 100 is used beneficially to facilitate entertaining a child seated in car seat 10. As illustrated, car-seat tray 100 may mount to car seat 10 through car-seat mount 105. Car-seat mount 105 connects to platform 110 and mounts platform 110 to car seat 10, in this version, using jaws 106. Car-seat mount 105 has four jaws 106 deployed pairwise to form clamps 107. Each of clamps 107 interacts with a corresponding portion of car seat 10, e.g. the right and left arms 11 of car seat 10.

The distance between jaws 106 of clamps 107 adjusts to accommodate differences in thickness of the relevant car seat part. And the distance between clamps 107 adjusts to accommodate differences in car seat width. Platform 110 serves as a table surface and as a member to connect table 101 to car-seat mount 105.

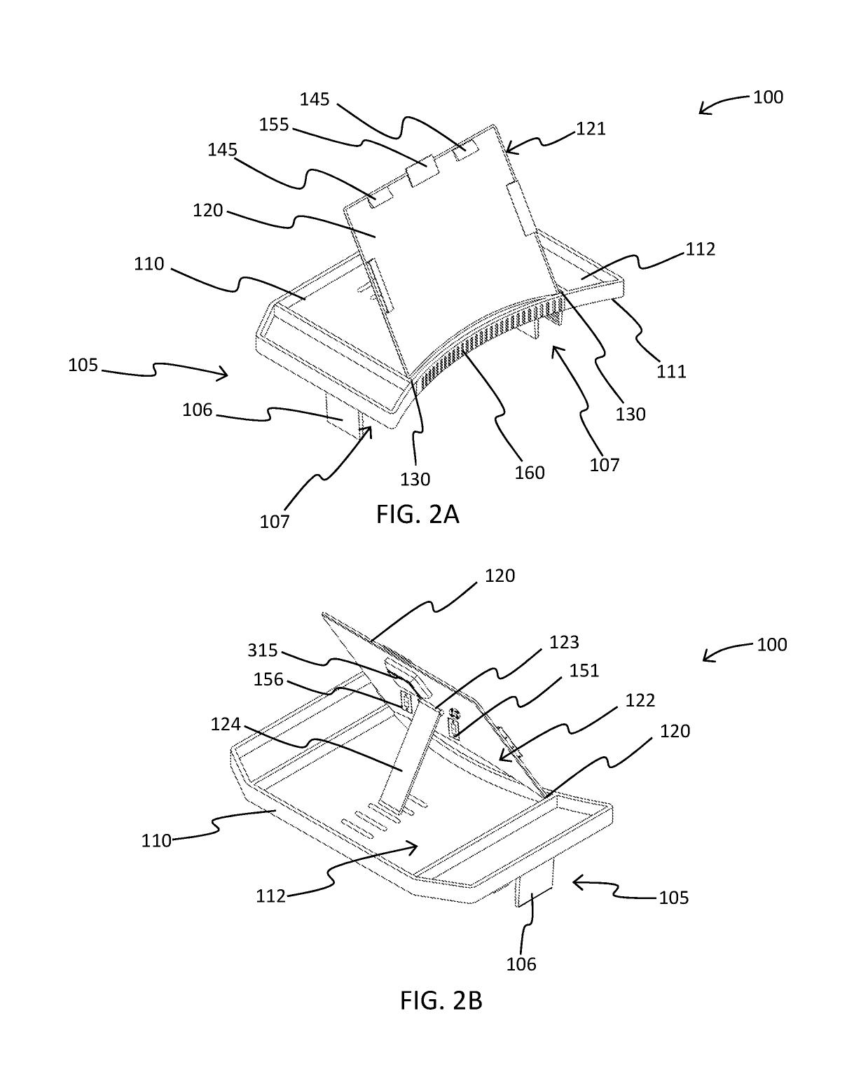

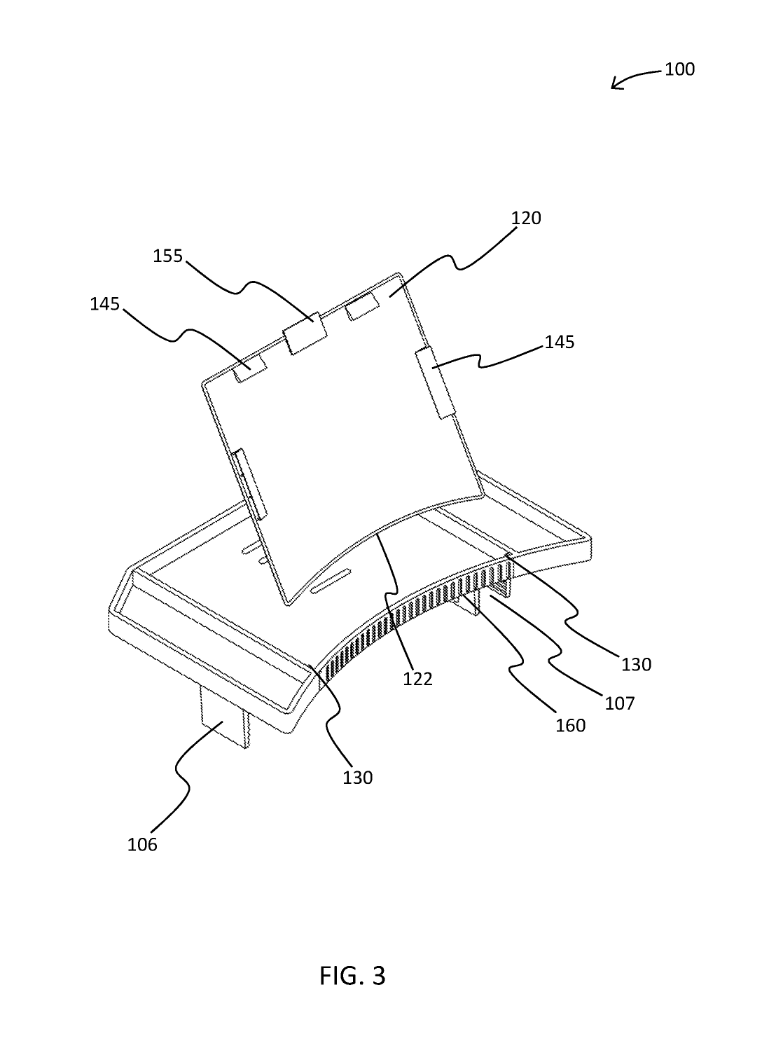

Turning to FIGS. 2A-FIG. 3, car-seat tray 100 has easel 120 mounted to platform 110, generally through mechanism 130. Mechanism 130 is rotatable or adjustable. In some versions, mechanism 130 comprises a stop on platform 110 to catch angled leg 124. Mechanism 130 joins easel bottom 122 to platform rear 111. This arrangement allows a child or caregiver to adjust the angle or height of easel 120. In the version depicted in FIGS. 2A-FIG. 3, angled leg 124 sits between easel bottom 122 and platform top 112 to prop easel 120 at a desired angle. Various other methods for raising easel 120 are known and can substitute for the arrangement between angled leg 124, platform 110, and easel 120. For instance, mechanism 130 can comprise a friction hinge sitting between the easel bottom 122 and platform top 112. The nature of this type of hinge allows it to maintain an angle without using an angled leg component.

Alternatively, slides (not shown) attach to easel sides 121 and platform top 112. These can be held to each other with threaded knobs, which can clamp sides 121 to platform 112 to maintain the angle. In some versions, mechanism 130 secures easel 120 well enough for a child to draw on or press against, but also provides for angle adjustment by the child. In some versions, mechanism 130 locks out angle adjustment by the child.

Car-seat tray 100 accepts many attachments that are useful in entertaining a child. FIGS. 2A-FIG. 3 depict easel 120 with several accessories, such as clips 145, a fan (not shown, but located behind vent 160), or light 155. Other tray accessories useful for entertaining a child, such as games, video monitors or cameras for providing visual media or for visually monitoring the child, can mount to easel 120, as well.

Clips 145 facilitate using a book on easel 120, by securing the book to withstand the natural movement of the traveling car. Likewise, clips 145 facilitate securing artwork, worksheets, or other activity-related items to easel 120. Other clipping or securing means may be used.

The fan, depending on the version of car-seat tray 100, mounts to easel 120, platform 110, or at any other point on car-seat tray 100, as is convenient. In some versions of car-seat tray 100, the fan is enclosed to prevent access to fan blades or blower components. Car-seat tray 100 versions like those depicted in FIGS. 2A-FIG. 3 use encased blowers or fans with vents 160 to supply airflow. In some versions, vents 160 are conveniently located along the edge or rear edge of platform 110.

Easel 120 assists with keeping the child entertained when confined in car seat 10, and the fan venting through vents 160 assists with keeping the child physically comfortable, since being strapped in a car seat frequently makes children too hot.

FIGS. 2A-FIG. 3 depict light 155 mounted on easel 120. Light 155 can be of any known type, suitable for use in a car's environment. In some versions, light 155 is an LED light. In some versions, light 155 has a color or configuration that allows the child to see, including allowing the child to see car-seat tray 100 and easel 120, while not degrading the driver's night vision. In some versions, light 155 is mounted on a portion of car-seat tray 100 other than easel 120. In various versions, light 155 is located along the edges of easel 120 such as along the top, bottom, or side edges of easel 120. Some versions of car-seat tray 100 have more than one light 155.

The fan and light 155 require power source such as battery or batteries 311 and car-seat tray 100 can include light switch 156 or fan switch 151 to operate the fan or light 155. The batteries reside in battery compartment 315 and are protected by battery compartment cover 316. Power source can be external to car-seat tray 100. For instance, the car's electrical system can serve as power source. Other power sources exist and are suitable for use with car-seat tray 100.

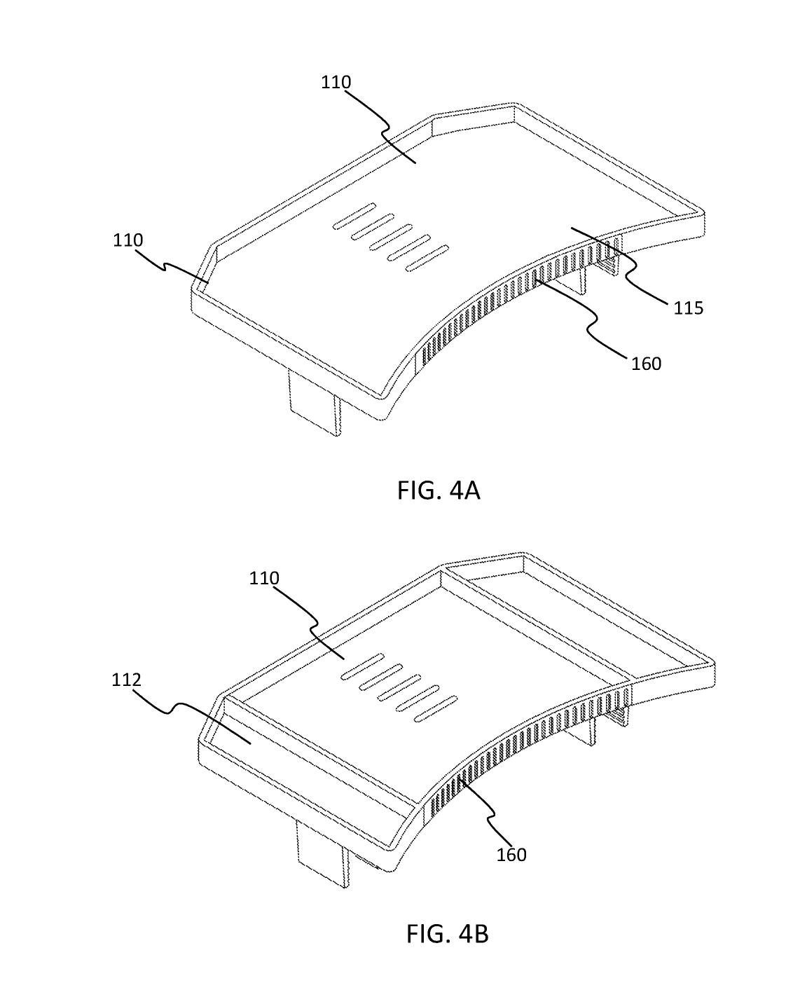

As shown in FIG. 4A, some versions of car-seat tray 100 comprise platform 110 having a substantially flat platform top 112. As shown in FIG. 4B, some versions of car-seat tray 100 comprise platform 110 having several compartments or depressions 113 in platform top 112, which can store or hold assorted items within the child's reach.

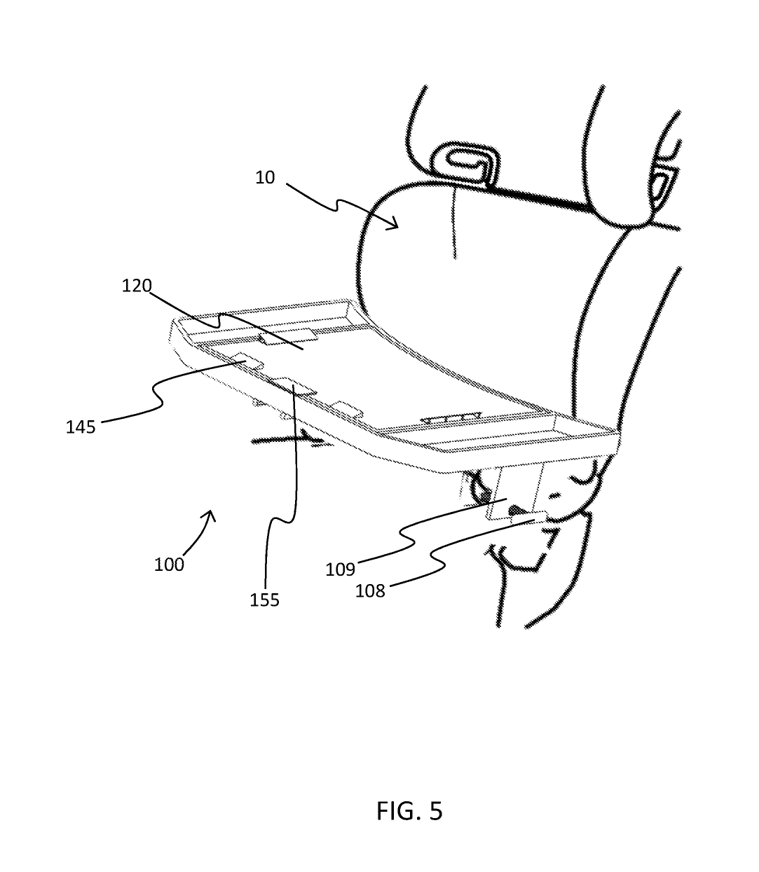

As shown in FIG. 5, some versions of car-seat tray 100 comprise car-seat mount 105 connecting with car seat 10 using a threaded post 108 through bracket 109 to apply pressure to car-seat arms 11. Other methods of connecting or mounting car-seat tray 100 are known to those with the requisite skill in the art.

In operation, after a caregiver seats the child in car seat 10, the caregiver mounts car-seat tray to car seat 10 across the child through an interaction between car-seat tray 100 and car seat 10, in some versions, using jaws 106 with clamps 107. The caregiver secures car-seat mount 105 to car seat 10 by connecting it to a portion of car seat 10 such as car-seat arms 11 and adjusting clamps 107 to arms 11. After installation, the child uses the surface of platform 110 to support play or other entertainment, as desired.

The child or caregiver inclines easel 120 for drawing, use as a bookstand, etc. and manages the inclination using angled leg 124 by adjusting it between easel back 123 and the platform top 112. Operationally, changing the position of angled leg 124 changes the angle that easel 120 makes with platform 110. In other versions, mechanism 130 maintains the inclination without angled leg 124, for example by using springs or friction surfaces within mechanism 130. As such, the child or caregiver angles easel 120 as desired and mechanism 130 holds it in place.

Clips 145 allow a book or other material to be movably secured to easel 120 for the child's enjoyment. That is, the child or caregiver mounts or secures a book or other material to easel 120 by clipping it to easel 120 with clips 145.

The fan is operable to provide ventilation for the child's physical comfort. In some versions, the child or caregiver operates the fan through fan switch 151 to send electricity from the power source to the fan to selectively ventilate the region around the child. In these or other versions, the child or caregiver operates light 155 to illuminate car-seat tray 100, as wanted or needed. In some versions, the child or caregiver operates light switch 156 to send electricity from power source to light 155.

In versions with an external power source (not shown), the child or caregiver connects the power source to, for example, an input jack on car-seat tray 100 so that car-seat tray 100 receives electricity from, e.g., the car. In versions that use batteries, the caregiver, or perhaps the child, installs batteries 311 into battery compartment 315 to provide electricity and closes battery compartment cover 316 to protect batteries 311. The fan and light 155 receive electricity from batteries 311. In some versions, the child or caregiver place food or tools, such as pens, pencils, or crayons into depressions 113 in platform 110 to prevent these items from falling or moving out of the child's reach.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A tray comprising:
a car-seat mount disposed between a platform and a car seat wherein the platform is connected to the car-seat mount;
an easel connected to the platform;
and
a fan.

2. The tray of claim 1 further comprising lights.

3. The tray of claim 2 wherein the fan is integrated in the platform.

4. The tray of claim 2 wherein the lights are reading lights.

5. The tray of claim 4 wherein the lights comprise an LED.

6. The tray of claim 2 further comprising an angled leg movably connected to the easel or the platform.

7. The tray of claim 6 wherein the angled leg sits between the easel and the platform such that the easel rests in an elevated position.

8. The tray of claim 7 wherein the car-seat mount includes jaws adapted to engage car seat sides.

9. The tray of claim 8 wherein the car seat is a forward-facing children's car seat.

10. The tray of claim 9 wherein the fan is integrated in the platform.

11. The tray of claim 9 further comprising a book clip.

12. The tray of claim 11 further comprising a power supply for the lights and alternately the fan.

13. The tray of claim 12 wherein the power supply further comprises a switch.

14. The tray of claim 13 wherein the car-seat mount includes jaws configured to engage sides of the car seat.

15. The tray of claim 13 wherein the fan is integrated in the platform.

16. The tray of claim 15 wherein the book clip connects to the easel.

17. The tray of claim 16 wherein the power supply comprises a battery and a battery compartment.

18. The tray of claim 1 wherein an angled leg sits between the easel and the platform such that the easel rests in an elevated position for use.

19. A tray comprising:
a car-seat mount clipping or friction fitting a platform to a forward-facing children's car seat wherein the platform connects to the car-seat mount;
an inclinable white-board easel hinged to the platform;
an angled leg mounted between the easel and the platform such that the easel rests in an elevated position;
a power supply containing a battery case mounted near the angled leg;
a switched fan integrated into the platform and electrically connected to the power supply;
and
a disposed on the platform, the easel, and alternately the car-seat mount and electrically connected to the power supply.

20. A tray comprising:
a mounting means for mounting, clipping, or friction fitting a platform to a forward-facing children's car seat wherein the platform connects to the mounting means;
an inclinable white-board easel connected to the platform;
an elevating means mounted between the easel and the platform such that the easel rests in an elevated position;
a power supply containing a battery case mounted near the elevating means;
a cooling means integrated into the platform and electrically connected to the power supply;
and
a lighting means disposed on the platform, the easel, and alternately the mounting means and electrically connected to the power supply.
